(19) United States
(12) Patent Application Publication
(10) Pub. No.: US 2005/0286059 A1
(43) Pub. Date: Dec. 29, 2005

(54) Attitude and position measurement of objects using image processing processes

(76) Inventor: Marc Michael Ellenrieder, Blaustein (DE)

Correspondence Address: PENDORF & CUTLIFF, 5111 Memorial Highway, Tampa, FL, 33634-7356, US

(21) Appl. No.: 11/125,050

(22) Filed: May 9, 2005

(30) Foreign Application Priority Data
May 7, 2004 (DE) 10 2004 023 322.5

(51) Int. Cl. G01B 11/14; G06K 9/00

(52) U.S. Cl. 356/614; 382/153

(57) ABSTRACT

The invention relates to a method for measuring the attitude and/or position of objects by means of image processing methods. In this case, the self-shading caused by a defined non-planar calibration element (3) is determined in a calibration process image and parameters (8) are then determined for correcting shadows with the aid of the self-shading detected. In this case, at least one object to be measured is introduced into the area of coverage of a camera (1) and into the area irradiated by lighting (2), in order to produce a picture of the object for the purpose of measuring the attitude and/or position. The picture of the object is subsequently corrected by means of the specific parameters (8), and the attitude and/or position of the object are/is determined therefrom. It is therefore possible with the aid of the invention to measure the attitude and/or position of objects in space reliably by using a single picture and the self-shading of a known calibration element (3). The distorted shadow boundaries, produced by the lighting (2), of the object to be measured can be determined uniquely with the aid of the method.

### BACKGROUND OF THE INVENTION

1. Field of the Invention

The invention relates to a method for measuring the attitude and/or position of objects by means of image processing methods.

2. Related Art of the Invention

Various image processing methods that are suitable for measuring the attitude and/or position of objects are already known. Such methods are chiefly used in the industrial sector in conjunction with sighted manipulation systems, for example in assembly or conjunction with autonomous mobile systems.

In order to measure the attitude and/or position of objects, it is possible to make use of image processing methods that are based, together with the use of suitable image sensors, on the processing of either two-dimensional or three-dimensional information about the surroundings. Image sensors that are suitable for detecting three-dimensional information about the surroundings in this case supply an associated depth value for each pixel. However, large data volumes occur during the detection of three-dimensional information on the surroundings, and so the processing of three-dimensional information on the surroundings is associated with a high outlay on computation and time. In addition, the human costs of image sensors for three-dimensional detection of the surroundings are substantially higher than for those that are suitable for two-dimensional detection of the surroundings.

Different image processing methods are already known for measuring the attitude and/or position of objects with the aid of two-dimensional image data. For example, two image sensors can be arranged in a stereo arrangement, it being possible, given a known spacing of the image sensors, to determine depth values computationally by the image processing methods. Also known are image processing methods in which an object is recorded with the aid of a number of cameras from different positions and orientation, and the position and orientation of the object in space is measured with the aid of the individual pictures.

The unpublished patent application with the file reference DE 10346481.6 discloses a method for reconstructing the profile of structures on surfaces. In the process, at least two pictures of the same area of the surface to be examined are evaluated, the surface to be examined being lit from various directions at a flat angle of incidence, and pictures of the surface being taken from a camera position with a steep angle to the surface. Elevations and depressions on the surface thus exhibit on the pictures a clear cast shadow whose attitude varies with the irradiation of light. Inclined surfaces can be identified by brighter reflection. By analyzing shadow contours and outlines of bright areas, it is possible to determine the height profile of a structure on the surface and thus to reconstruct, for example, the profile of a grate. It is also possible to determine flat changes in inclination by evaluating brightness profiles by integrating the shape-from-shading method, and thus to achieve a 3D reconstruction of the surface that corresponds well to the original.

EP 0747870 B1 discloses an apparatus and a method for observing objects. The apparatus comprises at least two cameras that are aligned in a predetermined observing position and simultaneously take images of objects to be observed. In the process, a common characteristic part is selected in each of the recorded images by correlating selected characteristic parts in each of the images. The position of objects, in particular the three-dimensional coordinates of the selected common characteristic parts, are calculated by using the position data of the selected characteristic part in each of the images. In the compute-intensive preprocessing of image data is a disadvantage here, it being necessary, particularly in different pictures, first to search for common features in order subsequently to intercorrelate the latter and then to use this information to calculate the three-dimensional coordinates of the object. A particular disadvantage is that a number of cameras and/or pictures are required to determine the attitude and/or position of objects.

### SUMMARY OF THE INVENTION

It is therefore the object of the invention to create a method for measuring the attitude and/or position of objects by means of image processing methods in accordance with the preamble of patent claim 1 with the aid of which the attitude and/or position of objects can be determined in a simple and reliable way by using a single picture.

The object is achieved according to the invention by means of a method having the features of patent claim 1. Advantageous refinements and developments of the invention are shown in the dependent claims.

Use is made according to the invention of a method for measuring the attitude and/or position of objects by means of image processing methods. In this case, self-shading caused by a defined non-planar calibration element is first detected in a calibration process image. Parameters for correcting shadows are then determined with the aid of the detected self-shading. In order to measure the attitude and/or position, at least one object to be measured is introduced into the area of coverage of a camera and into the area irradiated by lighting. At least one picture of the object is taken by the camera in the process. The at least one picture of the object is then corrected by means of the specific parameters, and the attitude and/or position are/is determined therefrom. The invention renders it possible for the first time to use a single picture to measure the attitude and/or position of objects in a simple and reliable way. In particular, it is possible owing to the inclusion of the defined non-planar calibration element and its self-shading to determine uniquely for the first time the distorted shadow boundaries of the object produced by the lighting during the measurement of the object.

A shadow image is additionally produced in one advantageous embodiment of the invention. For this purpose, the at least one picture, which contains the image of the object, is first transferred into the calibration process image. Image processing programs and raytraces are known to the person skilled in the art for this purpose. It is obvious here to select for the calibration process image the same camera parameters and lighting parameters as in the real scene in order to avoid a complicated conversion of camera parameters and lighting parameters. The calibration process image, which includes the calibration element, is preferably generated in this case in the raytracing environment, but there is also the possibility to use a picture of a known calibration element obtained by means of a camera. After the transfer of at least one picture, the object to be measured then casts shadows in the calibration process image onto the defined non-planar calibration element. The shadow of the object has distorted boundaries which are to be determined uniquely in order thereby to determine the attitude and/or position of the object. The shadow image is converted thereupon into a binary shadow image. The gray value pixels included in the calibration process image are converted for this purpose into black or white pixels. A quotient image is preferably formed with the aid of two shadow images in order to produce the binary image, one of the shadow images being produced with lighting, and the other shadow image being produced without lighting. This mode of procedure is known to the person skilled in the art of image processing and is applied, for example, in the shape from shadow method. Finally, a corrected shadow image is generated from the binary shadow image obtained, doing so with the aid of the previously determined correction parameters. The shadow of the object no longer has distorted boundaries in this case, but falls onto a plane and now constitutes a scaled image of the object from which the actual attitude and/or position in space can be determined.

In a further advantageous embodiment of the invention, a family of 3D connecting lines is determined with the aid of the corrected shadow image. This family of 3D connecting lines interconnects the shaded areas of the calibration element and the position of the lighting. Consequently, the family of 3D connecting lines can be used to reconstruct the attitude and/or position of the object to be measured, the family of determined 3D connecting lines describing the attitude and/or position of the object to be measured. In order to determine the attitude and/or position, in an advantageous way a stored geometry model of the at least one object to be measured is then fitted for this purpose into the family of the 3D connecting lines. Methods are already known for fitting stored geometry models into an image scene. An active contour algorithm is advantageously used within the scope of the invention to fit the geometry model of the object to be measured into the family of 3D connecting lines.

The geometry model of the object to be measured is preferably the model of at least one rigid and/or flexible object. For industrial applications, this can be, for example, rigid mounting means or fastening means, for example screws, covers and flanges, or flexible components such as, for example, tubes or conduits. It is advantageous in the context of the invention if further model data of the object are stored in addition to the pure geometry data. These can be, for example, the parameters describing the surface of the object, such as textures, for example. Also possible, however, are arbitrary further physical parameters. The geometry model and the further model data can be generated here directly within the raytracing environment and stored, or can originate from another suitable development environment, for example, from a CAD system.

In conjunction with the method according to the invention, it is also possible to produce the image of the calibration element from different spatial directions, a number of virtual cameras being defined therefor. Moreover, it is advantageous in addition that the image of the calibration element is lit from different spatial directions, a number of virtual lighting units being defined therefor. The attitude and/or position of arbitrary objects can be determined by virtue of the fact that a number of cameras and/or lighting units are defined. This eliminates the step in which a stored geometry model of the at least one object to be measured is fitted into the family of the 3D connecting lines, which contributes to saving computer time. However, it is particularly advantageous that the accuracy of the method is also improved with the use of a number of cameras and/or lighting units.

The calibration element used in conjunction with the invention is advantageously configured such that it is an element of step-like structure. On the one hand, the step-like structure can be generated in a simple way, for which purpose there are available, for example, macros that can be used to generate a step-like structure by stipulating the step height, step width and the number of steps. On the other hand, when use is made of a step-like structure the self-shading caused by suitable lighting can be accurately determined in a particularly simple way so as to be used to determine the attitude and/or position of the objects to be measured. Moreover, arbitrary other shapes of calibration elements are also possible in conjunction with the invention. It is possible, moreover, that the calibration element is formed by at least a part of the background of the area of coverage of the camera. For example, this can be at least one part of a motor, in particular of a crankcase that forms the background of the area of coverage of the camera. The object to be measured can be, for example, a hose that is to be fastened on the crankcase. Since both the model of the tube and also CAD data of the crankcase are known, only one camera is required in this case for measuring attitude and/or position.

### BRIEF DESCRIPTION OF THE DRAWINGS

Further features and advantages of the invention emerge from the following description of preferred exemplary embodiments with the aid of the figures, in which:

FIG. 1 shows a schematic for determining the self-shading,

FIG. 2 shows a schematic for determining parameters for correcting shadows,

FIG. 3 shows a distorted shadow image,

FIG. 4 shows a corrected shadow image, and

FIG. 5 shows an illustration for determining the attitude and/or position of an object.

### DETAILED DESCRIPTION OF THE INVENTION

FIG. 1 shows, by way of example, the principle for determining the self-shading in the case of a defined nonplanar calibration element (3). The attitude of the calibration element (3) and of the lighting (2) are presumed to be known in this case in the camera coordinate system (4). Moreover, the geometry model of the calibration element (3) is known—in a step form here. In addition, a geometry model of an object to be measured (not shown here) can be stored. To determine the self-shading, the CAD model of the calibration element (3) is imaged via a camera model corresponding to the camera (1), as is shown with the aid of FIG. 1, by way of example. Thereafter, the course of lines of sight (5) is determined, starting from the lighting (2) as far as the camera (1), for each pixel in the image (raytracing). Each line of sight (5) that runs between a point of intersection (6) of the calibration element and the lighting (2) is checked in this case as to whether it cuts the calibration element (3), therefore giving rise to self-shading. As is to be seen from the example of the line of sight (5a), the calibration element is not cut, and so there is no self-shading at the point of intersection (6a). In the case of the line of sight (5b), by contrast, the calibration element (3) is cut, and so there is self-shading at the point of intersection (6b).

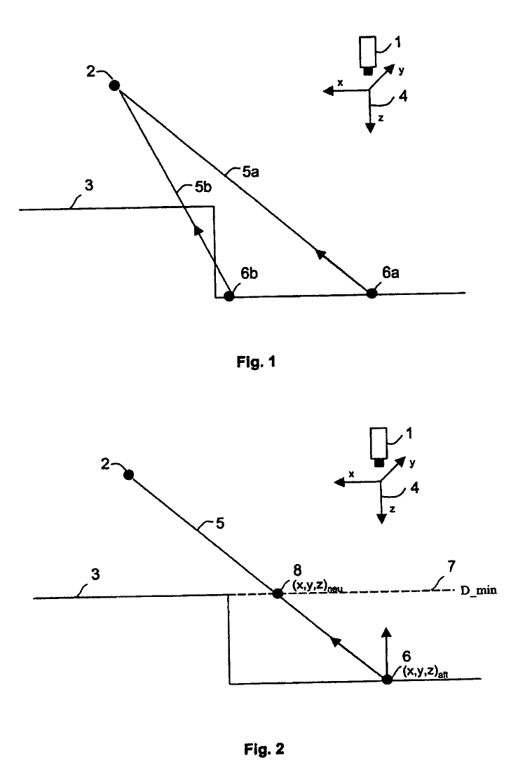

The principle for determining parameters for correcting shadows is shown by way of example in FIG. 2. Here, it is preferred in a first step that includes taking account of all points of intersection (6) of the calibration element (3) that are not self-shaded to determine that plane (7) which has the smallest spacing D_min between the calibration element (3) and the camera (4), and is oriented in this case parallel to the X, Y-plane of the camera (1). However, it is also possible alternatively to select any other arbitrary known spacing and another arbitrary orientation of the plane (7). In a second step, the point of intersection (8) with the plane (7) is then determined for all non-self-shaded points of intersection (6) of the calibration element (3), doing so with the aid of a displacement of the point of intersection (6) in the direction of the lighting (2) on the associated line of sight (5). A shadow point of an object to be measured (not shown here) would have been imaged at this point of intersection (8) on the plane (7) if the surface of the calibration element (3) were a plane (7) parallel to the image plane of the camera (1). The displacement on the line of sight (5) here describes the parameters for correcting shadows from which it is possible in what follows to reconstruct the attitude and/or position of objects in a simple way. An object to be measured is introduced in this case into the region between the area of coverage of the camera (1), which is irradiated by means of the lighting (2), and the calibration element (3) for the purpose of taking a picture.

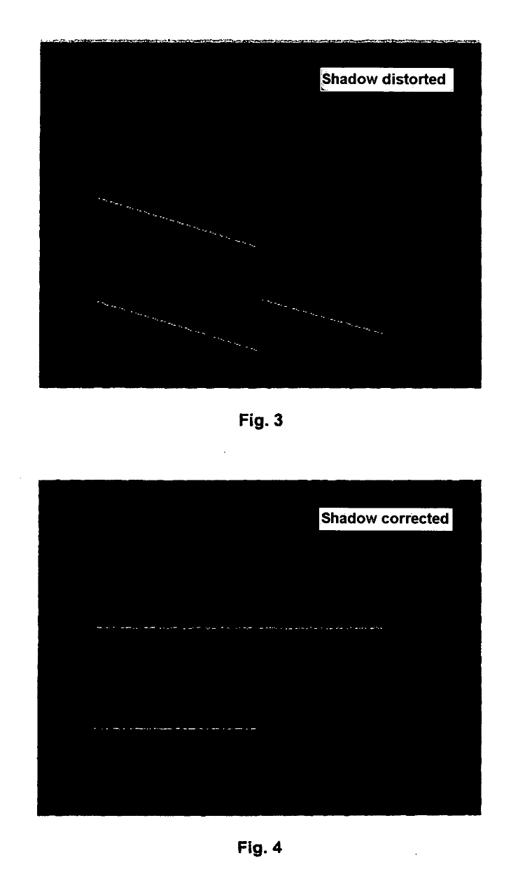

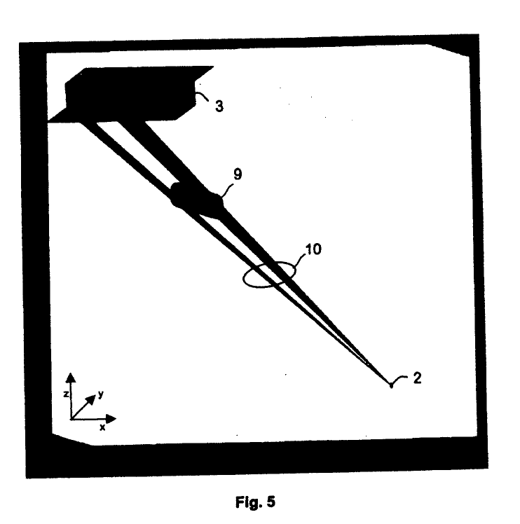

FIG. 3 shows a distorted shadow image. This is a distorted shadow image of a step-like calibration element in the binary display. The binary display of the shadow image is formed in this case by means of a quotient image, the quotient image originating from two shadow images. The two shadow images differ solely in that one of the shadow images is produced with lighting, and the other shadow image is produced without lighting. The shadow pixels are displayed by white in the image. Each shadow pixel is thereupon checked as to whether it is a self-shaded pixel. If there is a self-shaded pixel, it is deleted. A new position in the image is determined for the remaining shadow pixels by using the previously determined parameters for correction, as was described with the aid of FIG. 2. As shown in FIG. 4, the corrected shadows are now piecewise parallel. The corrected, piecewise parallel shadows were additionally rotated in this case by a specific angle so that they run in a horizontal direction in the image.

As illustrated in FIG. 5, all 3D connecting lines (10) between the object points, assigned to the shadow pixels, on the calibration element (3) and the lighting (2) are subsequently determined in order to reconstruct the attitude and/or position of an object (9). If model data of the object (9) to be measured are stored, the object is fitted into the family of the 3D connecting lines (10) by using a suitable algorithm.

1. A method for measuring the attitude and/or position of objects by means of image processing methods, comprising:
detecting self-shading caused by a defined non-planar calibration element in a calibration process image,
using the detected self-shading to determine specific parameters for correcting shadows,
introducing at least one object to be measured into the area of coverage of a camera and into the area irradiated by lighting, and
taking at least one picture of the object with the camera,
wherein the at least one picture of the object is corrected by means of the specific parameters, and the attitude and/or position are/is determined therefrom.

2. The method for measuring the attitude and/or position of objects by means of image processing methods as claimed in claim 1, wherein
a shadow image is produced, the at least one picture of the object being transferred into the calibration process image, the object casting shadows onto the calibration element,
the shadow image is converted into a binary shadow image, and
a corrected shadow image is generated from the binary shadow image with the aid of previously determined correction parameters.

3. The method for measuring the attitude and/or position of objects by means of image processing methods as claimed in claim 2, wherein
the corrected shadow image is used to determine a family of 3D connecting lines that interconnects the shaded areas of the calibration element and the lighting, the family of 3D connecting lines describing the attitude and/or the position of the object.

4. The method for measuring the attitude and/or position of objects by means of image processing methods as claimed in claim 3, wherein
a stored geometry model of the at least one object to be measured is fitted into the family of the 3D connecting lines.

5. The method for measuring the attitude and/or position of objects by means of image processing methods as claimed in claim 4, wherein
an active contour algorithm is used to fit the geometry model into the family of 3D connecting lines.

6. The method for measuring the attitude and/or position of objects by means of image processing methods as claimed in claim 1, wherein
the geometry model of the object to be measured is the model at least of a rigid or flexible object.

7. The method for measuring the attitude and/or position of objects by means of image processing methods as claimed in claim 1, wherein
the image of the calibration element is produced from different spatial directions, a number of virtual cameras being defined therefor.

8. The method for measuring the attitude and/or position of objects by means of image processing methods as claimed in claim 1,
wherein
the image of the calibration element is lit from different spatial directions, a number of virtual lighting units being defined therefor.

9. The method for measuring the attitude and/or position of objects by means of image processing methods as claimed in claim 1, wherein
the calibration element is an element of step-like structure.

10. The method for measuring the attitude and/or position of objects by means of image processing methods as claimed in claim 1, wherein
the calibration element is formed by at least a part of the background of the area of coverage of the camera.
